(19) United States
(12) Patent Application Publication
(10) Pub. No.: US 2026/0231309 A1
(43) Pub. Date: Aug. 6, 2026

(54) LIGHTING DEVICE OPERATION STATUS ESTIMATION DEVICE AND METHOD OF ESTIMATING AN OPERATION STATUS OF A LIGHTING DEVICE

(71) Applicant: SIGNIFY HOLDING B.V., EINDHOVEN (NL)

(72) Inventors: MATTHIAS WENDT, Würselen (DE); PETER DEIXLER, ARLINGTON, MA (US)

(21) Appl. No.: 19/152,195

(22) PCT Filed: Jan. 29, 2024
(86) PCT No.: PCT/EP2024/052077

§ 371 Date: Jul. 30, 2025

Related U.S. Application Data
(60) Provisional application No. 63/444,137, filed on Feb. 8, 2023.

(30) Foreign Application Priority Data
Mar. 31, 2023 (EP) 23166000.2

(51) Int. Cl. H05B 47/155; H05B 47/165

(52) U.S. Cl. CPC H05B 47/155; H05B 47/165

(57) ABSTRACT

The invention is directed to a lighting-device operation-status estimation device (100) for estimating an operation status of a target lighting device (502) that is configured to provide a respective incarnation of a machine-learning engine (104) with an initial parameter set (P) to a plurality of lighting device providers (106, 108, 110), to receive, from at least a subset of the plurality of the lighting device providers, engine data (Ea, Eb, Ec) indicative of a respective trained machine-learning engine (104a, 104b, 104c) trained using a respective proprietary training data set (Ta, Tb, Tc) provided by the lighting device provider, using the respective engine data, to generate and provide an updated machine-learning engine (105) and, using the updated machine-learning engine (105) and current device data (D), to generate and provide device-status data (M) indicative of the operation status of the target lighting device with an

### FIELD OF THE INVENTION

The invention is directed to a lighting-device operation-status estimation device, to a lighting-device operation-status estimation arrangement, to a method of estimating an operation status of a target lighting device, to a use of a machine-learning engine for performing the method of estimating the operation status of the lighting device, to a training data set for training a machine-learning engine for estimating the operation status and to a computer program.

### BACKGROUND OF THE INVENTION

Document CN110287640A describes a life estimation method for lighting equipment and a corresponding device, where the method includes obtaining a correlation model between the plurality of lighting devices, acquiring real-time data of a portion of the lighting devices and determining an abnormal lighting device according to the real-time data. A service life of the abnormal lighting device is determined and, according to this service life, the life of a target device associated with the abnormal lighting device in the correlation model is estimated.

### SUMMARY OF THE INVENTION

Reliable predictions of remaining life time of lighting assets, such as lighting devices as well as reliable predictions of operation status for determining an optimal maintenance strategy for lighting installations or lighting arrangements will be a key differentiator for data-driven connected lighting solutions. However, in practice sharing data collected across different end users and countries is hampered by many practical factors (available connectivity bandwidth, cost of ingesting vast amounts of sensor data in the cloud) as well as regulatory hurdles (GDPR). However, the quality of inference for machine learning depends on having a sufficient number of labeled examples for each failure mode. As lighting devices are designed very reliable, they typically show around a 3% failure rate over a 10 year period. Hence, labeled failures to be used for training a supervised machine-learning model such as in the case of document CN110287640A are difficult to obtain.

However, a sufficient number of labeled cases, e.g., failures or maintenance issues, are required for each of the multitude of maintenance modes of a lighting device in order for the machine-learning model to reliably infer operation status or maintenance requirements when deployed to the field. Especially short product life cycles and ever-changing production and application conditions are challenging the engineers in charge of developing a reliable maintenance strategy for lighting devices in lighting installations or arrangements. Currently, lighting devices, including their LEDs and electronics components, do not remain in production for a long time, e.g., 10 years. Hence, in order to perform machine-learning, there is a need to tap into the data of every possible maintenance issue or failure that is available.

Similarly, nowadays lighting devices also use many newly developed 3D printing filament materials, which can be advantageously analyzed by machine-learning techniques to early recognize yet-unknown mechanical-or optical stability failure modes in the field. There is hence a need for a way to cross learn across an extended installed base of lighting devices.

It would be beneficial to increase the accuracy of the estimation of the operation status of lighting devices.

According to a first aspect of the invention, a lighting-device operation-status estimation device for estimating an operation status of a target lighting device is disclosed.

The lighting-device operation-status estimation device comprises a machine-learning engine provision unit that is configured to provide a respective incarnation of a machine-learning engine with an initial parameter set to a plurality of lighting device providers, wherein each lighting device provider provides respective lighting devices for one or more lighting installations. Here, incarnation may refer to an instantiation or version of an initial “base” model, i.e., the machine-learning engine, with a specific set of parameters (the initial or updated parameter set). The lighting-device operation-status estimation device also comprises an engine-data reception unit configured to receive, from at least a subset of the plurality of the lighting device providers, respective engine data indicative of, i.e., derived from or based on a corresponding trained machine-learning engine that has been trained using a respective proprietary training data set that comprises status data and/or operation data of test lighting devices provided by the respective lighting device provider. That is, the engine data, i.e., the updated parameter set, have been derived by training the machine-learning engine with a respective proprietary training data set that comprises status data and/or operation data of test lighting devices provided by the respective lighting device provider. The lighting-device operation-status estimation device also comprises a machine-learning engine update unit that, using the respective received engine data, is configured to generate and provide an updated machine-learning engine, and an operation status estimation unit configured, using the updated machine-learning engine and current device data comprising status data and/or operation data of the target lighting device, to generate and provide device-status data indicative of the operation status of the target lighting device. The device-status data for a given target lighting device is thus estimated using an updated machine-learning engine that is generated using the engine data provided by the subset of the plurality of lighting device providers, and not only based on the proprietary training data set of the corresponding lighting device provider, which has the effect of increasing the reliability of the estimation of the operation status and thus, for example, of enabling an optimized maintenance schedule.

The invention relies on the understanding that machine-learning techniques allow for creating detailed insights about faults, wear and product aging in order to early on flag field quality issues and/or support future predictive maintenance use cases in lighting devices of lighting installations, which may range from small smart-home installations to large city-wide installations, such as installations in the frame of Interact City or City Touch (e.g., lighting device installation with a large number of luminaires, such as approximately 100.000 luminaires in Jakarta). The concept of swarm-based machine-learning (SBML) across independent lighting device providers opens the opportunity for aggregating the product-reliability model learnings throughout the whole range of lighting devices without introducing new privacy and security risks. Lighting device providers may include vendors, operators of lighting installations, original equipment manufacturers, etc.

The invention relies thus on applying SBML for lighting devices (e.g., luminaires, controls, driver electronics, packaging, etc.) to provide a lighting-device operation-status estimation device based on a solid and ever learning machine-learning model, which can estimate operation status and, based thereon, recommend optimal maintenance schedules. Specifically, the use of SBML technology allows for an integration of the individual reliability model learnings by the participating lighting device providers, i.e., internal and external parties across many different markets, in particular, original equipment manufacturers (OEM), vendors, nodes, etc. The collaboratively trained SBML enables to infer the failure of a specific lighting device installed in the field, hence improving the uptime of the lighting system and allowing for optimized maintenance planning.

The lighting-device operation-status estimation device is advantageously configured to provide a respective incarnation of the machine-learning engine, that includes an initial parameter set to each of the participating lighting device providers (e.g. OEM), which provide respective lighting devices for one or more lighting installations. The lighting-device operation-status estimation device thus provides, as the incarnation of the machine-learning engine, a suite of machine learning analytic functions to perform analytics on a given data set. Each of the lighting device providers uses the respective proprietary training data set to train their incarnation of the machine-learning engine. The respective incarnation is thus trained using training data set that comprises status data and/or operation data of test lighting devices provided by the lighting device provider according to the specific usage conditions of the lighting devices. That is, each lighting device provider receives the initial “base model” or machine learning engine with the initial set of parameters that serves as the starting point to train their updated instances/versions of the base model using training data set that comprises status data and/or operation data of test lighting devices provided by the lighting device provider according to the specific usage conditions of the lighting devices.

The term test lighting device refers to those lighting devices whose status data and/or operation data is used by the respective lighting device provider for training the corresponding machine-learning engine. Thus, the test lighting devices associated to a given lighting device provider comprise at least a subset of the respective lighting devices provided by said provider. Sharing the engine data obtained or generated by each of the lighting device providers broadens the types of failure mode of a luminaires grasped by the updated machine-learning engine and thus enables the updated machine-learning engine to reliably infer operation status for deployed lighting devices, based on current device data of the target lighting device. The device-status data generated and provided by the operation status estimation unit is indicative of current operational state of the lighting device and can be indicative of whether a maintenance action is expected to be required within a given time-span for a given target lighting device and enables a better planning of a maintenance service schedule. The device-status data can for instance be related to operation parameters of the lighting device such as drift in the correlated color temperature or lighting intensity.

The updated machine-learning engine is generated by merging the engine data provided by each of the lighting device providers to obtain a common engine. The merging can for instance be done by calculating the parameters as a mean value, a weighted mean value or using median algorithms of the parameters of the trained machine-learning engines.

In a particular embodiment, the device-status data is maintenance data indicative of a maintenance requirement of the target lighting device. Thus, this particular embodiment is configured as a maintenance-requirement estimation device for estimating a maintenance requirement of the target lighting device and comprises, as the operation status estimation unit, a maintenance requirement estimation unit that, using the updated machine learning and current device data comprising status data and/or operation data of the target lighting device, is configured to generate and provide the maintenance data indicative of the maintenance requirement of the target lighting device. The maintenance data can be indicative of a requirement of a maintenance action, and includes an indication for a service action (e.g., replacement, repair, cleaning, recalibration, change in location, etc.). Additionally, or alternative, it can comprise an operation instruction for mitigating the cause or the effect of an estimated failure, thereby extending the life time of the lighting device and preventing a total disruption of operation of the lighting device before the service action takes place.

In a preferred embodiment, the lighting-device operation-status estimation device further comprises a lighting control unit, connected to the lighting-device operation-status estimation unit (or to the maintenance requirement estimation unit), or part thereof, and configured to provide, using the device-status data, operation instructions for operating the target lighting device. Therefore, the knowledge obtained by applying the current device data to the updated machine-learning engine, in the form of device-status data can be used to control operation of the target lighting device, for instance for operating it in a way that may prolong its expected life time, such as, for example, by limiting the light intensity output, changing cooling parameters, preventing off-on cycles of the lighting device, etc.

According to a second aspect of the invention, a lighting-device operation-status estimation arrangement, is disclosed, which comprises a lighting-device operation-status estimation device according to the first aspect of the invention and a plurality of machine-learning engine units that are configured to receive, from the lighting-device operation-status estimation device, a respective incarnation of the machine-learning engine with the initial parameter set; to provide, for training the machine-learning engine, a respective proprietary training data set comprising status data and/or operation data of test lighting devices provided by the respective lighting device provider; to determine, using the proprietary training data set and the respective incarnation of the machine-learning engine, an updated parameter set indicative of the trained machine-learning engine, and to provide engine data indicative of respective trained machine-learning engine to the lighting-device operation-status estimation device.

The arrangement of the second aspect of the invention can be implemented as a maintenance-requirement estimation arrangement, wherein the device-status data is maintenance data indicative of a maintenance-requirement of the target lighting device.

Each of the machine-learning units its associated to a respective lighting device provider and are configured to be trained using the respective proprietary training data set available to the corresponding lighting device provider.

Preferably, and in order to maintain sensitive information associated to the proprietary training data set, only the updated parameter set is provided to the lighting-device operation-status estimation device. While the lighting device providers share their incrementally improved updated parameter set (e.g. weights of the neural network making the operation status inferences), these providers still keep all their customer-, maintenance- and product-specific information for themselves. Thus, the lighting device providers, e.g. OEM's do not need to share any specific data and may benefit from an improved estimation of operation statuses. This collaboratively improved reliability model utilizing a plurality of lighting device providers enables an acceleration of reliability learnings, particularly over different world regions, product usage and stress patterns, to which different lighting installations are subject to. The SBML approach results in a continuous adaptation of the reliability models by means of machine learning.

The lighting-device operation-status estimation device and/or the machine-learning engine units can be implemented as software in respective computer systems with output and input interfaces from providing and receiving data i.e., the incarnations of the machine-learning engine, the engine data (e.g. the updated parameter set) and the device-status data.

The device-status data is in a particular embodiment generated and provided by the machine-learning units that are associated to the plurality of lighting device providers.

Preferably, the device-status data is indicative of a maintenance action expected to be required for a given lighting device. In an embodiment, the device-status data additionally or alternatively includes an operation instruction for operating the target lighting device to increase an expected operational life time, for example, limit the maximum light intensity, increase a cooling of the lighting unit, etc. This operation instruction can be provided to the respective lighting device provider or directly to the target lighting device for controlling its operation. In a preferred embodiment, the device-status data, when it is indicative of a requirement of a maintenance action, includes an indication for a service action (e.g., replacement, repair, cleaning, recalibration, change in location, etc.) as well as an operational instruction for mitigating the cause or the effect of an estimated failure, thereby extending the life time of the lighting device and preventing a total disruption of operation of the lighting device before the service action takes place.

In an embodiment of the arrangement, a respective operation status estimation unit is comprised or owned by one or more of the lighting device providers, which can therefore use current device data of their lighting devices to obtain the device-status data or the maintenance data.

A third aspect of the present invention is formed by a method of estimating an operation status, and/or a maintenance requirement, of a target lighting device. This method includes the steps of:
providing a respective incarnation of a machine-learning engine with an initial parameter set to a plurality of lighting device providers, each lighting device provider providing respective lighting devices for one or more lighting installations;
each lighting device provider providing a respective proprietary training data set to the corresponding incarnation for training the machine-learning engine, wherein the training data set comprises status data and/or operation data of test lighting devices provided by the lighting device provider;
each lighting device provider determining, using the proprietary training data set and the respective incarnation of the machine-learning engine, an updated parameter set indicative of the trained machine-learning engine;
each lighting device provider providing engine data indicative of the respective trained machine-learning engines for generating an updated machine-learning engine; and
using the updated machine-learning engine and current device data comprising status data and/or operation data of the target lighting device, generating and providing device-status data (e.g. in the form of maintenance data) indicative of the operation status or maintenance requirement of the target lighting device.

The method of the third aspect of the inventions shares the advantages of the lighting-device operation-status estimation device of the first aspect and of the lighting-device operation-status estimation arrangement of the second aspect.

In the following, embodiments of the method of the third aspect will be described. These embodiments are adapted to be carried out by a respective embodiments of the lighting-device operation-status estimation device in agreement with the first aspect of the invention or of the lighting-device operation-status estimation arrangement in agreement with the second aspect advantageously adapted therefor.

In an embodiment, the incarnations of the machine-learning engine, the trained machine-learning engine and the updated machine-learning engine are implemented using blockchain. Due to the blockchain implementation, any data changes can be reliably retrieved, and no wrong or malicious parameter sets can be inserted without traceability by the lighting device providers. In addition, future service contracts can be sold for simply generating a new instance of the updated machine-learning engine.

In an embodiment, the device-status data generated additionally or alternatively comprises operational life time data indicative of an expected remaining useful life time of the target lighting device.

Also, preferably, and in order to ensure data privacy of the proprietary training data set of the respective lighting device providers, in an embodiment of the method, the engine data provided by the lighting device provider comprises, or preferably solely consists of, at least a portion of the updated parameter set. For instance, a given lighting device provider may decide to share only subset of the updated parameters, e.g. those related to the driver health impact of lightning strikes but not those related to driver health degradation related to a cold start of LED drivers.

Thus, the lighting device providers, e.g. the OEM's, only share the parameters, or part thereof, of the trained machine-learning engine or neural net and not the training data set itself. This approach requires much less communication bandwidth and lowers the data-ingestion cost for each lighting device provider's cloud. In addition, some lighting device providers may not accept that their customer data is in the hand of another party. Nevertheless, there is a desire from each participating lighting device provider to co-learn with the other providers to improve the estimation of the operation status or the expected operational life time of target lighting devices. Preferably, the updated parameter set gets encrypted before being provided, in particular to the lighting-device operation-status estimation device, and shared with all other instances of the machine-learning engine implemented in the remaining machine-learning engine units associated to each of the remaining lighting device providers, or OEM's, participating in the collaborative, jointly owned SBML model. In this way all partner engines keep on the same state of learning without exchange of the training data itself.

In another embodiment, the method further comprises providing the updated machine-learning engine to one or more of the plurality of lighting device providers and/or to one or more third-party lighting device provider. Thus, for instance, service contracts can be provided or sold to non-participating lighting device providers or other third parties for generating another incarnation of the updated machine-learning engine. In an embodiment, the method comprises generating and transmitting a respective updated machine-learning engine to the participating providers or third-parties. For instance one provider may opt not to participate in a certain aspect such as useful life inference after lighting strike, as they think they already have sufficient proprietary knowledge in that particular field. A second provider may participate and share information in that regard. The updated machine-learning engine provided to each of the providers may therefore be different.

Preferably, the method includes providing a service to associated partners and optionally also to end customers where information regarding the expected operation status or the expected operational life time is made available. For instance, certificates (e.g. in the form of QR codes) detailing the reliability model's inferences and/or expected operation status or the expected operational life time can be provided. These certificates are useful for the second-hand market. Useful life predictions by a swarm model need to have a proof of being both authentic and provide the confidence of the inference. Thanks to the proposed SBLM-based collaboration across manufacturers, or other lighting device providers, the SLBM-based model can learn from more labeled failures, resulting in higher confidence of the remaining useful life inferences than a single OEM could achieve on his own. As lighting devices only fail seldom, having observations about luminaire failures is very precious.

In a preferred embodiment, the proprietary training data set comprises status data and/or operation data indicative of one or more of lighting device metadata, environmental data associated to environmental conditions at a location of operation of the lighting device, failure data indicative of operation failures of the lighting device and service data indicative of service actions performed on the lighting device, and which may include, for example a replacement action of any of the components of the lighting device, a repair action of any of the components of the lighting device, a cleaning action of any of the components of the lighting device, a recalibration action of any of the components of the lighting device, a change of location of the lighting device, etc. In particular, the lighting device metadata is indicative of one or more of a type of lighting device, a serial number of the lighting device, a production date of the lighting device, a production location of the lighting device, a location of operation or installation of the lighting device, a usecase of the lighting device (e.g. indoor, outdoor), lighting device components, e.g. hardware components, of the lighting device and/or a driver type of the lighting device, e.g. software components.

Additionally, or alternatively, in a particular embodiment, the environmental data is indicative of weather conditions during operation of the lighting device at the location of installation and/or environmental data indicative of those conditions the lighting device has been exposed to before installation, such as storage conditions. For instance, the environmental data includes a time-series weather data comprising, for example, temperature data, humidity data, solar irradiation data, wind velocity data, icing data and/or lightning strike data. The environmental data can be determined by sensors integrated in the respective lighting devices or from dedicated external sensors. Storage conditions are also relevant, since a lighting device stored under high heat conditions may be damaged or have a reduced expected lifetime. Similarly, cold temperature exposure during storage of LED drivers may already result in components, such as SMD diodes and capacitors being pulled out of the PCB due to the potting asphalt crystallizing at low temperature.

In another embodiment, the proprietary training data set includes failure or performance data, including, for instance, data indicative of lux-measurements, color, point in the field, life-time data etc. The proprietary training data set may further comprise image data or light-sensor data indicative of a lux-level of one or more lighting devices, for example day time and/or night time satellite images of streetlights that can be used to infer a current performance state of a given lighting device as well as the physical surroundings of each of the lighting devices within the image.

In another embodiment, the method further comprises the step of encrypting the engine data indicative of the respective trained machine-learning engines before providing it for generating the updated machine-learning engine, in particular providing encrypted updated engine parameters as encrypted engine data.

Preferably and in order to ensure accountability and traceability of the device-status data and/or the maintenance data, the method may further comprise the step of storing the device-status data, in particular using blockchain technology, in particular on a memory unit of the lighting device. The device-status data, which may also include an expected remaining life time of the lighting device, can be advantageously used for pricing the lighting device for the second hand market.

A fourth aspect of the present invention is formed by a use of a machine-learning engine, or a lighting-device operation-status estimation arrangement of the second aspect, for performing the method of estimating the operation status of the lighting device according to the third aspect of the invention.

A fifth aspect of the invention if formed by a training data set for training a machine-learning engine for estimating an operation status in accordance with the method of the third aspect. The training data set comprises status and/or operation data of test lighting devices, in particular status and/or operation data indicative of one or more of lighting device metadata, environmental data associated to environmental conditions at a location of operation of the lighting device, failure data indicative of operation failures of the lighting device and service data indicative of service actions performed on the lighting device.

According to a sixth aspect, a computer program is disclosed. The computer program comprises instructions which, when executed by a computing system of a lighting-device operation-status estimation arrangement according to the second aspect, cause the computing system to carry out the method of the third aspect.

The present invention allows, among others, the enhanced prediction for potential failures, thereby improving the maintenance planning of a (street)lighting installation. Furthermore, the updated machine-learning engine provides a solid basis for an estimation of the remaining useful life of lighting devices, thereby fueling a secondhand market for lighting devices, including like drivers, led engines and luminaires. The collaboratively improved reliability model based on the updated machine-learning engine (utilizing data provided by the plurality of lighting device providers) will speed up product reliability learnings over different world regions, product usage and stress patterns (e.g. ambient temperature). The SBML approach results in a continuous adaptation of the reliability models by means of machine learning; due to the possibility of frequent retraining (e.g. the updated machine-learning engine can be provided again as a respective incarnation of a machine-learning engine to all of the participating providers, to be re-trained using proprietary training data sets), the model can accommodate shifts of product usage over time changing, and drifts in the production conditions & used materials. Besides, the providers do not need to share the training data set and still get the benefit of improved reliability inferences of their installed lighting devices.

The invention can be advantageously used to train a machine-learning engine for predicting remaining lifetime of lighting assets and for determining optimal maintenance strategy for a lighting installation. It allows to exploit labeled data, e.g., data collected from lighting devices and installations across different end users and regions or countries, without requiring sharing data among independent businesses.

It shall be understood that the lighting-device operation-status estimation device of claim 1, the lighting-device operation-status estimation arrangement of claim 3, the method of estimating an operation status of a target lighting device of claim 4, the use of the lighting-device operation-status estimation arrangement of claim 13, the training data set of claim 14 and the computer program of claim 15, have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows a schematic block diagram of a lighting-device operation-status estimation arrangement according to an embodiment of the invention and including a lighting-device operation-status estimation device and a plurality of machine-learning engine units,

FIG. 2 shows a flow chart including exemplary training steps for swarm-based machine-learning (SBLM) implemented by a lighting-device operation-status estimation arrangement in accordance with the invention, and

FIG. 3 shows a flow diagram of a method for estimating an operation status of a target lighting device in accordance with an embodiment of the invention.

### DETAILED DESCRIPTION OF EMBODIMENTS

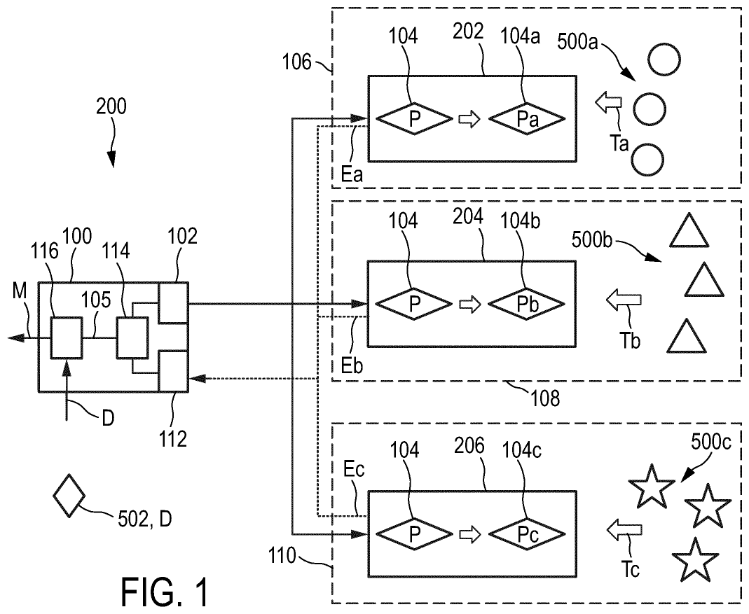

FIG. 1 shows a schematic block diagram of a lighting-device operation-status estimation arrangement 200 according to an embodiment of the invention and including a lighting-device operation-status estimation device 100 and a plurality of machine-learning engine units 202, 204, 206. Each machine-learning unit is associated to a respective lighting device provider 106, 108, 110. Each lighting device provider provides respective lighting devices 500a, 500b, 500c, for instance for one or more lighting installations. Each of the plurality of machine-learning engine units 202, 204, 206 is configured to receive, from the lighting-device operation-status estimation device 100, a respective incarnation of the machine-learning engine 104 with the initial parameter set P. The incarnations 104 are provided via a machine-learning engine provision unit 102. Each of the machine-learning engine units is also configured to provide, for training the machine-learning engine 104, the respective proprietary training data set Ta, Tb, Tc comprising status data and/or operation data of test lighting devices 500a, 500b, 500c provided by the respective lighting device provider 106, 108, 110. The proprietary training data set comprises status data and/or operation data indicative of one or more of lighting device metadata, environmental data associated to environmental conditions at a location of operation of the lighting device, failure data indicative of operation failures of the lighting device and service data indicative of service actions performed on the lighting device. For example, the lighting device metadata may be indicative of one or more of a type of lighting device, a serial number of the lighting device, a production date of the lighting device, a production location of the lighting device, a location of operation of the lighting device, a use case of the lighting device, lighting device components of the lighting device and a driver type of the lighting device. The environmental data in turn can be indicative of weather conditions during operation of the lighting device at the location of installation or of storage conditions that the lighting device has been exposed to prior to the installation. The proprietary training data set may further comprise image data or light-sensor data indicative of a lux-level of one or more lighting devices. The proprietary training data may be partly or wholly determined or ascertained by sensing devices integrated within the lighting device or associated to the lighting installation. Additionally or alternatively the proprietary training data or part of it can be provided by external sensors or systems, such as, but not limited to, weather stations or satellites.

The machine-learning units 202, 204, 206 are also configured to determine, using the respective proprietary training data set Ta, Tb, Tc and the respective incarnation of the machine-learning engine 104, a respective updated parameter set Pa, Pb, Pb that is indicative of the trained machine-learning engine, and to provide respective engine data Ea, Eb, Ec indicative of respective trained machine-learning engine 104a, 104b, 104c to the lighting-device operation-status estimation device. Thus, even though each of the machine-learning units 202, 204, 206 starts with an incarnation or instance of the same machine-learning engine with the same starting parameters (e.g. coefficients), they are trained using different proprietary training data sets Ta, Tb, Tc which are indicative of the operation or of the state of those lamps administered by the respective lighting device providers. As a results, each of the incarnations of the machine-learning engine evolves toward a different set of updated parameters Pa, Pb, Pc. For instance, lighting devices 500a, provided by the provider 202 are typically used in a humid tropical environment in outdoor location and the trained machine-learning engine will tend to estimate with an increase reliability failure modes or maintenance actions related to humid conditions, whereas lighting devices 500b, provided by the provider 204, are typically used in indoor locations in Tucson, where the conditions are much drier, and the possible failure modes are not significantly related to high humidity conditions. However, the engine data Ea, Eb, Ec indicative of the respective trained machine-learning engines, is provided back to the lighting-device operation-status estimation device 100. The engine data is received at an engine data reception unit 112 that is configured to receive, from at least a subset of the plurality of the lighting device providers 202, 204, 206, engine data Ea, Eb, Ec indicative of a respective trained machine-learning engine 104a, 104b, 104c trained using the respective proprietary training data set Ta, Tb, Tc that comprises status data and/or operation data of test lighting devices 500a, 500b, 500c provided by the respective lighting device provider.

A machine-learning engine update unit 114 is configured, using the respective received engine data Ea, Eb, Ec, to generate and provide an updated machine-learning engine 105 which includes therefore knowledge from every one of the trained machine-learning engines of the participating lighting device providers, thereby increasing the amount of possible failure modes or maintenance requirements to which the updated engine is capable to identify. An operation status estimation unit 116 which is comprised by the lighting-device operation-status estimation device 100, is configured, using the updated machine-learning engine 105 and current device data D comprising status data and/or operation data of the target lighting device 502, to generate and provide device-status data, for example as maintenance data M indicative of the operation status (e.g. a maintenance requirement) of the target lighting device 502. The target lighting device may belong to any of the sets of lighting devices provided by any of the lighting device providers 106, 108, 110 or may belong to an non-participating entity, i.e., another provider not involved in the training and upgrading of the machine-learning engine 104, and just benefiting from the common knowledge provided by the enlarged effective combined training data set.

Additionally or alternatively, the lighting device providers may comprise a respective operation status estimation unit for estimating the operation status, e.g. the maintenance requirement. Preferably, the updated machine-learning engine 105 is also provided to one or more of the plurality of lighting device providers and/or to one or more third-party lighting device provider. The updated machine-learning engine is then run on each of the machine-learning engine units associated to each of the lighting device providers, which can then benefit from the extended case data base (e.g. based on data obtained from all sets of lighting devices 500a, 500b, 500c) that has resulted in the updated machine-learning engine 105.

Therefore, using the updated machine-learning engine 105, either at the lighting-device operation-status estimation device 100 or at any one of the machine-learning engine units 202, 204, 206, together with current device data D of any given target lighting device 502, which may or may not belong to any of the lighting device providers 106, 108, 110, an operation status for said target device 502 can be estimated with an increased reliability, since the updated machine-learning engine 105 results from a larger data base than any of the trained machine-learning engines 104a, 104b, 104c of the lighting device providers alone.

Preferably, and in order to reduce the bandwidth necessary for the arrangement 200 and to ensure the secrecy of the proprietary training data sets Ta, Tb, Tc, the engine data Ea, Eb, Ec provided by the lighting device provider solely consists of the respective updated parameter set Pa, Pb, Pc, or at least a subset thereof.

Preferably, the device-status data M comprises operational life time data indicative of an expected remaining useful life time of the target lighting device, and even more preferably the device-status data, is stored, in particular using blockchain technology, on a memory unit of the lighting device of and/or a database associated to the lighting device provider.

In an exemplary arrangement 200, the updated machine-learning engine is used to infer the remaining useful life of a specific target lighting device already installed in the field. In a particular example, all of the lighting devices provided by the providers utilize the same driver hardware and the same driver firmware, while other aspects such as the lighting device's optics differ between the providers.

In another exemplary arrangement 200, the updated machine-learning engine is advantageously used to infer—e.g., at a fleet basis—the average remaining useful life of an outdoor streetlamp installation (e.g. a City Touch installation) comprising a large number of luminaires (e.g. approximately 100 k luminaires in Jakarta). The information regarding the remaining useful life can be used for instance for pricing a contract renewal of the lighting installation. For instance, using the updated machine-learning engine, it may be inferred that between year 10 and 15, 25% of the luminaries of the lighting installation under analysis project installed will experiment failure or an operation status and/or maintenance requirement and this information can be used to adjust the price.

In a further development of the arrangement 200, the updated machine-learning engine is used to infer the remaining useful life of a specific lighting device, information which can be stored, e.g., on the luminaire, in blockchain to ensure accountability and traceability. The remaining useful life information is then used for pricing the luminaire for the 2^{nd} hand market.

In a further development of the arrangement 200, the updated machine-learning engine is advantageously used to infer the Tier 1, Tier 2 and Tier 3 carbon footprint for different operation-and maintenance scenarios for the lighting devices, in particular streetlights. For instance, a luminaire may be frequently switched by a motion sensor, which saves energy and hence Tier 1 carbon emissions, but the frequent switching results in a shortening of the remaining useful life, hence resulting in an increased Tier 3 carbon emission.

In a further development of the arrangement, the lighting devices 500a, 500b 500c include at least two different types of drivers. In this case, the incarnations of the machine-learning engine 104 can be advantageously trained using detailed metadata about the electronics design of the different types of drivers, such that the updated machine-learning engine is sensitive to the consequence of electronics design choices on the product reliability and/or product performance like carbon footprint over product life. After the incarnations 104 have been trained with labelled failure data originating from different LED driver electronics designs, the updated machine-learning engine can be used for predicting the expected product life or operation status or maintenance requirements when considering electronics design changes of the LED drivers.

Thus, an exemplary development of the arrangement 200 is suitable for closing-based on the reliability insights generated by the updated machine-learning engine-the loop from product reliability insights to automated electronics design and based thereupon, upgrade the lighting device driver with an alternative, in particular more expensive component. E.g. a different 3D printed housing for better cooling, a better capacitor. The upgrade of the electronics design may be location specific; for instance, for LED drivers to be used in Arizona the model recommends a first capacitor while for a streetlighting project in Alaska a second type of capacitor is recommended. Similarly, also the luminaire housing may be customized e.g. with a different 3D printed heatsink.

In a further developed arrangement 200, each lighting device provider (e.g., OEM) can add night-time satellite images of corresponding streetlighting projects to extract the health state of each installed light as well as the physical surrounding of each streetlights (incl. current lux level).

In a further developed arrangement 200, a decision criteria is employed for what ensemble of models to use e.g. a first model used for improving the wireless communication of the wireless driver or a second model to predict immediate capacitor failures vs. a third model tasked to predict the aggregated failures over the next five years.

In another exemplary arrangement, the device-status data, e.g. maintenance data, or part thereof, is provided as a service to partners and probably also to end customers. For instance, a (QR) code certificate detailing the reliability model's inferences can be provided; for this (QR) code certificate being useful for the second-hand market, the remaining useful life predictions by the updated machine-learning engine need to have a proof of being both authentic and provide the confidence of the inference. Thanks to the disclosed SBLM-based collaboration across lighting device providers (e.g. manufacturers), the updated machine-learning engine can learn from more labeled failures, resulting in higher confidence of the remaining useful life inferences than a single provider could ever achieve on its own. As lighting devices only fail seldom, having observations about luminaire failures is very precious.

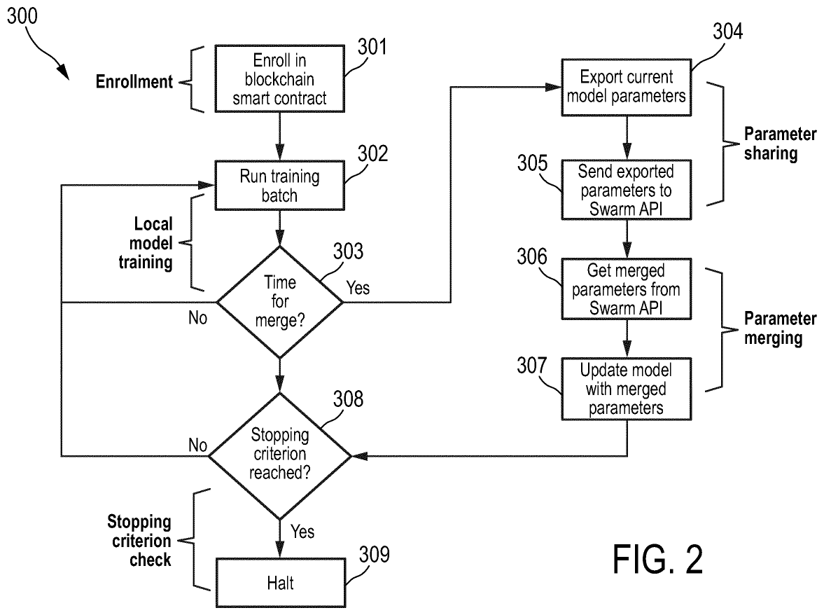

FIG. 2 shows a flow chart 300 including exemplary training steps for swarm-based machine-learning (SBLM) that can be implemented by a lighting-device operation-status estimation arrangement in accordance with the invention. Swarm-Based learning is a decentralized machine learning (ML) solution that uses edge computing and is built on blockchain technology for peer-to-peer collaboration. Using a private-permission blockchain, only the model structure and its trained parameters—not the training data set itself—are shared, which ensures data security and privacy while still allowing all to benefit from the collective learnings. Data sovereignty, security, and privacy requirements can all create barriers to transferring and aggregating the vast amount of data required to train sophisticated ML models. Above all, the swarm-based solution has no single point of failure. All results of earlier learnings are stored in the distributed ML engines each of which has equal rights/capabilities.

In a first step 301, the participating partners enroll in a blockchain smart contract. An incarnation of an ML engine is received by all participating partners and trained separately using respective proprietary training data set in step 302. Upon fulfillment of a trigger condition checked in step 303, the participating partners export the current model parameters, in a step 304, and send them to a swarm application programming interface (API), in a step 305. A set of merged parameters is obtained in step 306 and the model is updated using the merged parameters, in a step 307. A stopping criterion is checked in step 308. Depending on the fulfillment of the stopping criterion the whole process is stopped in a step 309 (when fulfilled) or the updated model is further trained in step 302.

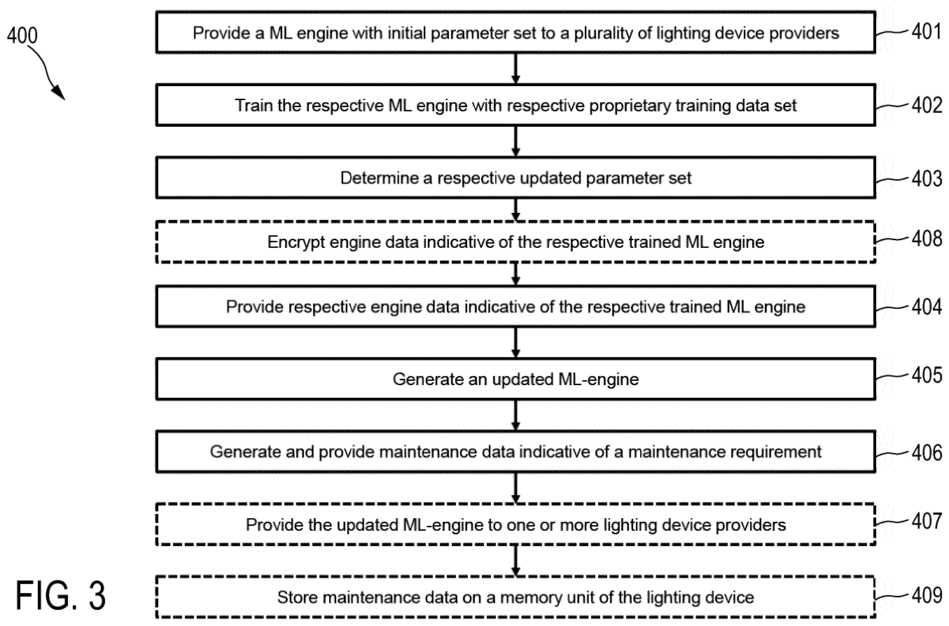

FIG. 3 shows a flow diagram of a method 400 for estimating an operation status, such as a maintenance requirement, of a target lighting device in accordance with an embodiment of the invention. The method comprises providing, in a step 401, a respective incarnation of a machine-learning engine with an initial parameter set to a plurality of lighting device providers, each lighting device provider providing respective lighting devices for one or more lighting installations. The method further comprises, in a step 402, providing, a respective proprietary training data set to the corresponding incarnation for training the machine-learning engine, wherein the training data set comprises status data and/or operation data of test lighting devices provided by the lighting device provider. The method further comprises, in a step 403, determining, using the proprietary training data set and the respective incarnation of the machine-learning engine, an updated parameter set indicative of a trained machine-learning engine. The method further comprises, in a step 404, providing engine data indicative of the respective trained machine-learning engines for generating, in a step 405, an updated machine-learning engine. The method further comprises, in a step 406, generating and providing device-status data indicative of the operation status, such as a maintenance requirement, of the target lighting device, using the updated machine-learning engine and current device data comprising status data and/or operation data of the target lighting device. Preferably, the device-status data comprises operational life time data indicative of an expected operational life time of the target lighting device, and preferably, the engine data provided by the lighting device provider consists of the updated parameter set.

The method 400 may optionally comprise, in a step 407, providing the updated machine-learning engine to one or more of the plurality of lighting device providers and/or to one or more third-party lighting device provider. Optionally, the provided updated machine-learning engine can be used as an incarnation of a machine-learning engine, as the one provided in step 401, for further training and updating the machine-learning engine. This cyclic training can be performed until a predetermined stopping criterion is met. The stopping criterion is typically a reliability-based criterion, where a reliability threshold indicative of the significance of the estimation must be surpassed before the cyclic training of the ML engine is stopped.

Preferably, the method 400 further includes encrypting, in a step 408 the engine data indicative of the respective trained machine-learning engines before providing it for generating the updated machine-learning engine, in particular providing encrypted updated engine parameters as engine data.

Additionally or alternatively, an exemplary method 400 includes, in a step 409, storing the device-status data, in particular using blockchain technology, on a memory unit of the lighting device.

In general, a pretrained model, referred to as a machine-learning engine, which is based on a fixed model architecture, is shared with the lighting device providers, such as OEMs. Over time, the OEMs provide, as proprietary training data, the luminaire's metadata (luminaire type, GPS location, etc.,) , environmental data (time series weather data incl. storms, lighting strikes), as well as failure events and service actions into the model; after locally re-training his ML model with his proprietary data set, the OEM shares the updated ML engine parameters with the other OEMs participating in the swarm co-learning. Thus, the distributed SBML parameter set merges and aggregates all OEM learnings from different luminaire vendors on reliability or product performance over time etc. without any sharing of actual project or customer data being required.

In summary, the invention is directed to a lighting-device operation-status estimation device for estimating an operation status of a target lighting device is configured to provide a respective incarnation of a machine-learning engine with an initial parameter set to a plurality of lighting device providers, to receive, from at least a subset of the plurality of the lighting device providers, engine data indicative of a respective trained machine-learning engine trained using a respective proprietary training data set provided by the lighting device provider, using the respective engine data to generate and provide an updated machine-learning engine and, using the updated machine-learning engine and current device data, to generate and provide device-status data indicative of the operation status of the target lighting device with an increased reliability.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

1. A lighting-device operation-status estimation device for estimating an operation status of a target lighting device which comprises:
a machine-learning engine provision unit configured to provide a respective incarnation of a machine-learning engine with an initial parameter set (P) to a plurality of lighting device providers, wherein each lighting device provider provides respective lighting devices for one or more lighting installations;
an engine-data reception unit configured to receive, from at least a subset of the plurality of the lighting device providers, respective engine data (Ea, Eb, Ec), said engine data comprising solely or at least a portion of an updated parameter set (Pa, Pb, Pc) derived from a corresponding trained machine-learning engine, trained using a respective proprietary training data set (Ta, Tb, Tc) comprising status data and/or operation data of test lighting devices provided by the lighting device provider;
a machine-learning engine update unit configured, using the respective updated parameter set, to generate and provide an updated machine-learning engine from the machine-learning engine and
an operation status estimation unit configured, using the updated machine-learning engine and current device data (D) comprising status data and/or operation data of the target lighting device to generate and provide device-status data (M) indicative of the operation status of the target lighting device.

2. The lighting-device operation-status estimation device as defined by claim 1, wherein the operation status estimation unit is additionally configured to generate, using the device-status data, and provide operation instructions for operating the target lighting device.

3. A lighting-device operation-status estimation arrangement, comprising:
a lighting-device operation-status estimation device according to claim 1; and
a plurality of machine-learning engine units configured to receive, from the lighting-device operation-status estimation device a respective incarnation of the machine-learning engine with the initial parameter set, to provide, for training the machine-learning engine, the respective proprietary training data set (Ta, Tb, Tc) comprising status data and/or operation data of test lighting devices provided by the respective lighting device provider, to determine, using the proprietary training data set and the respective incarnation of the machine-learning engine, a respective updated parameter set (Pa, Pb, Pc) derived from the trained machine-learning engine and to provide said updated parameter set to the lighting-device operation-status estimation device.

4. A method of estimating a device operation status of a target lighting device including the steps of:
providing a respective incarnation of a machine-learning engine with an initial parameter set to a plurality of lighting device providers, each lighting device provider providing respective lighting devices for one or more lighting installations;
each lighting device provider providing a respective proprietary training data set to the corresponding incarnation for training the machine-learning engine, wherein the training data set comprises status data and/or operation data of test lighting devices provided by the lighting device provider;
each lighting device provider determining using the proprietary training data set and the respective incarnation of the machine-learning engine, an updated parameter set derived from a trained machine-learning engine;
each lighting device provider providing engine data indicative of the respective trained machine-learning engines for generating an updated machine-learning engine; and
using the updated machine-learning engine and current device data comprising status data and/or operation data of the target lighting device, generating and providing device-status data indicative of the operation status of the target lighting device.

5. The method of claim 4, wherein the device status data comprises operational life-time data indicative of an expected remaining useful lifetime of the target lighting device.

6. The method of claim 4, further comprising providing the updated machine-learning engine to one or more of the plurality of lighting device providers and/or to one or more third-party lighting device provider.

7. The method of claim 4, wherein the proprietary training data set comprises status data and/or operation data indicative of one or more of lighting device metadata, environmental data associated to environmental conditions at a location of operation of the lighting device, failure data indicative of operation failures of the lighting device and service data indicative of service actions performed on the lighting device.

8. The method of claim 7, wherein the lighting device metadata is indicative of one or more of a type of lighting device, a serial number of the lighting device, a production date of the lighting device, a production location of the lighting device, a location of operation of the lighting device, a use case of the lighting device, lighting device components of the lighting device and a driver type of the lighting device.

9. The method of claim 7, wherein the environmental data is indicative of weather conditions during operation of the lighting device at the location of installation and/or environmental data indicative of conditions the lighting device has been exposed to before being its installation.

10. The method of claim 4, wherein the proprietary training data set further comprises image data or light sensor data indicative of a lux-level of one or more lighting devices.

11. The method of claim 4, further comprising the step of storing the device-status data, in particular using blockchain technology, on a memory unit of the lighting device.

12. Use of a machine-learning engine or a lighting-device operation-status estimation arrangement according to claim 3, for performing the method of estimating the operation status of the target lighting device according to claim 4.

13. Computer program comprising instructions which, when executed by a computing system of a lighting-device operation-status estimation arrangement according to claim 3, cause the computing system to carry out the method of claim 4.
